(19) United States
(12) Patent Application Publication
(10) Pub. No.: US 2026/0225033 A1
(43) Pub. Date: Aug. 6, 2026

(54) HIGH CAPACITY PRODUCTION OF CARBON MOLECULAR SIEVE MEMBRANES

(71) Applicant: University of Maryland, College Park, College Park, MD (US)

(72) Inventors: Chen Zhang, Laurel, MD (US); Ching-En Ku, Adelphi, MD (US)

(21) Appl. No.: 19/370,371

(22) Filed: Oct. 27, 2025

Related U.S. Application Data
(60) Provisional application No. 63/712,519, filed on Oct. 27, 2024.

(51) Int. Cl. B01D 53/22; B01D 67/00; B01D 69/08; B01D 71/02

(52) U.S. Cl. CPC B01D 53/228; B01D 67/0067; B01D 69/087; B01D 71/021; B01D 2053/224; B01D 2256/10; B01D 2256/22; B01D 2256/24; B01D 2256/245; B01D 2257/102; B01D 2257/104; B01D 2257/108; B01D 2257/11; B01D 2257/504; B01D 2257/7022; B01D 2257/7027; B01D 2323/081

(57) ABSTRACT

The present disclosure relates to carbon molecular sieve membranes, methods of making carbon molecular sieve membranes through bundle pyrolysis, and uses thereof for separating a mixture of gases. The carbon molecular sieve membranes formed by bundle pyrolysis of the present invention can be readily scaled to dozens or hundreds of fibers per module, retain excellent gas selectivity properties, and are able to be selective towards separating gases, such as H₂, from a mixture of gases, and are faster to produce compared to carbon molecular sieve membranes formed through individual pryolysis.

### CROSS REFERENCE TO RELATED APPLICATIONS

This application claims priority to U.S. Application No. 63/712,519, filed on Oct. 27, 2024, the contents of which are hereby incorporated by reference in its entirety.

### STATEMENT OF FEDERALLY SPONSORED RESEARCH AND DEVELOPMENT

This invention was made with government support under DE-EE0010313 awarded by the U.S. Department of Energy. The government has certain rights in the invention.

### FIELD OF THE INVENTION

The field of the invention relates generally to carbon molecular sieve membranes, methods of making carbon molecular sieve membranes, and uses thereof for separating a mixture of gases. More specifically, the field of the invention relates to methods of increasing the production speed of carbon molecular sieve hollow fiber membranes.

### BACKGROUND

This background information is provided for the purpose of making information believed by the applicant to be of possible relevance to the present invention. No admission is necessarily intended, nor should it be construed, that any of the information disclosed herein constitutes prior art against the present invention.

The efficient separation and purification of gases from natural and industrial sources is an ongoing endeavor in commercial and energy producing industries. Polymer hollow fiber membranes have broad commercial applications for industrial gas separations such as air separation and natural gas purification. Scaling up of polymer hollow fiber membranes is relatively inexpensive and well understood in the gas separation membrane industry. However, polymer membranes are limited by the permeability-selectivity tradeoff, and high-performance inorganic membranes are required to expand the boundary of membrane-based gas separations beyond air separation and natural gas purification. Carbon molecular sieve (CMS) membranes are amorphous inorganic membranes made by pyrolysis of polymer precursor membranes above their thermal decomposition temperatures. During pyrolysis, the aromatic polymer backbone decomposes to provide disorderly packed graphene sheets (micropores) with slit-like ultramicropores between neighboring aromatic strands. This unique pore structure allows CMS membranes to achieve high permeability and high selectivity overcoming the Robeson upper bounds. 1, 2

CMS hollow fiber membranes can be made from pyrolysis of precursor polymer hollow fiber membranes. This pyrolysis is traditionally performed with individually spaced polymer precursor hollow fibers (i.e., individual pyrolysis) on a stainless-steel mesh within a sealed quartz tube. Oxygen is typically removed from the quartz tube through a vacuum or displacement by an inert gas, such as ultrapure argon. The pyrolysis proceeds by increasing the temperature of the tube at a constant rate for an extended period called a ramping step. A single pyrolysis can have multiple ramping steps, typically culminating with a period of maintaining a constant high temperature before cooling the tube, typically through natural heat dissipation to ambient room temperature.

Production of commercial-scale CMS hollow fiber membrane modules has not occurred. CMS hollow fiber membranes are traditionally made by individual pyrolysis which significantly limits the production speed of CMS hollow fiber membranes. It is well established in the art that having precursor fibers touching each other in a bundle during pyrolysis (i.e., bundle pyrolysis) will result in CMS hollow fibers fusing together and that the fusing would lead to significantly reduced membrane area and permeance.

Previous work has been done to increase the efficiency of individually spacing the precursor hollow fibers. PCT/US2018/043006 discloses a silicon-based separation layer between the individual fibers to prevent the total substrate collapse during individual pyrolysis. However, arranging the individual fibers makes scaling CMS hollow membrane fibers made in this way time consuming and economically unfeasible. For example, a single batch of individual pyrolysis would take at least 5 hours and can only give less than 10 CMS hollow fibers. Therefore, producing 1000 CMS hollow fibers would take 500 hours.

As such, there is a need for a method of producing industrially viable CMS hollow fiber membranes without needing to arrange individual fibers or separation layers to prevent substrate collapse during pyrolysis. Further, there is a need for a method of producing CMS hollow fiber membranes via bundle pyrolysis such that over 100 CMS fibers can be incorporated into a CMS hollow fiber membrane while maintaining gas permeance and comparable gas selectivity to CMS hollow fiber membranes made by individual pyrolysis.

### SUMMARY

One aspect of the invention pertains to a method of making carbon molecular sieve (CMS) hollow fiber membranes, said method comprising providing precursor hollow fiber membranes, inserting said precursor hollow fiber membranes into a tubing, and bundle pyrolyzing said metal tubing containing said precursor hollow fiber membranes in a furnace to obtain CMS hollow fiber membranes.

Another aspect of the invention pertains to a carbon molecular sieve membrane, said membrane comprising at least 20, about 20 to about 1,000,000, about 100 to about 1,000,000 or about 1000 to about 100,000, about 30 to about 10,000 hollow fibers.

### BRIEF DESCRIPTION OF FIGURES

The following drawings form part of the present specification and are included to further demonstrate certain aspects of the present invention. The disclosure may be better understood by reference to one or more of these drawings in combination with the detailed description of specific embodiments presented herein. The patent or application file contains at least one drawing executed in color. Copies of this patent or patent application publication with color drawing(s) will be provided by the Office upon request and payment of the necessary fee.

FIG. 1. FIG. 1 displays a diagram of a single-layer hollow fiber spinning apparatus.

FIG. 2. FIG. 2 displays a photo of polymer hollow fiber bundle.

FIGS. 3A-3D. FIG. 3A displays SEM images taken by a Tescan XEIA3 FEG scanning electron microscope showing the morphology of precursor hollow fiber membranes before pyrolysis (FIGS. 3A-3B) and CMS hollow fiber membranes after (FIGS. 3C-3D) pyrolysis.

FIGS. 4A-4F. FIG. 4A displays a photo showing the precursor hollow fiber bundle and stainless-steel tubing. FIG. 4B displays a photo showing the CMS hollow fiber bundle made by bundle pyrolysis. FIG. 4C displays a photo showing a module containing the CMS hollow fiber bundle shown in FIG. 4B. FIG. 4D displays a graph comparing He/N₂ permeation results in CMS hollow fiber membranes made by traditional individual pyrolysis and bundle pyrolysis. FIG. 4E displays a graph comparing CO₂/CH₄ permeation results in CMS hollow fiber membranes made by traditional individual pyrolysis and bundle pyrolysis. FIG. 4F displays a graph comparing H₂/C₃H₈ permeation results in CMS hollow fiber membranes made by traditional individual pyrolysis and bundle pyrolysis.

FIGS. 5A-5D. FIG. 5A displays a 100 polyimide hollow fiber bundle. FIG. 5B displays a 100 CMS hollow fiber bundle. FIG. 5C displays a cross-section view of the module comprising 100 CMS hollow fibers made by bundle pyrolysis-FIG. 5D displays a side view of the same module shown in FIGS. 6A-6D. FIG. 6A displays a photo of a <5-8 CMS fibers/batch. FIG. 6B. displays a photo of a 27-CMS hollow fiber bundle. FIG. 6C. displays a photo of a 65-CMS hollow fiber bundle. FIG. 6D displays a photo of a 100-CMS hollow fiber bundle.

FIG. 7. FIG. 7 displays a graph of scaled-up 100-CMS hollow fiber membrane module showed attractive room-temperature separation performance with H₂ permeance of 23 GPU and H₂/C₃H₈ selectivity of 28.

FIG. 8. FIG. 8 displays a graph of the 100-CMS hollow fiber membrane module within 70% of H₂ permeance and H₂/C₃H₈ selectivity of CMS hollow fiber pyrolyzed at small batches.

### DESCRIPTION

All publications mentioned herein are incorporated by reference to the extent they support the present invention.

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of”

As used herein, the term “about” refers to a +10% variation from the nominal value. It is to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

The term “THF” as used herein refers to tetrahydrofuran.

The term “rt” as used herein refers to room temperature.

The term “alkyl” as used herein by itself or as part of another group refers to both straight and branched chain radicals, and cyclic alkyl groups. In one embodiment, the alkyl group has 1-12 carbons. In another embodiment, the alkyl group has 1-7 carbons. In another embodiment, the alkyl group has 1-6 carbons. In another embodiment, the alkyl group has 1-4 carbons. The term “alkyl” may include methyl, ethyl, propyl, isopropyl, butyl, t-butyl, isobutyl, pentyl, hexyl, isohexyl, heptyl, 4,4-dimethylpentyl, octyl, 2,2,4-trimethylpentyl, nonyl, decyl, undecyl, and dodecyl.

The term “heteroalkyl,” as used herein, by itself or in combination with another term, means, unless otherwise stated, a linear or branched chain having at least one carbon atom and at least one heteroatom selected from the group consisting of O, N, S, P, and Si. In certain embodiments, the heteroatoms are selected from the group consisting of O, and N. The heteroatom(s) may be placed at any interior position of the heteroalkyl group or at the position at which the alkyl group is attached to the remainder of the molecule. Up to two heteroatoms may be consecutive.

The term “alkylene” as used herein refers to straight and branched chain alkyl linking groups, i.e., an alkyl group that links one group to another group in a molecule. In some embodiments, the term “alkylene” may include —(CH₂)ₙ— where n is 2-8.

The term “aryl” as used herein refers to a polyunsaturated hydrocarbon substituent. Aryl groups can be monocyclic or polycyclic (e.g., 2 to 3 rings that are fused together or linked covalently). Non-limiting examples of aryl and heteroaryl rings are phenyl, naphthyl, pyranyl, pyrrolyl, pyrazinyl, pyrimidinyl, pyrazolyl, pyridinyl, furanyl, thiophenyl, thiazolyl, imidazolyl, isoxazolyl, and the like.

The term “heteroaryl” as used herein refers to groups having 5 to 14 ring atoms; 6, 10 or 14 π-electrons shared in a cyclic array; and containing carbon atoms and 1, 2 or 3 oxygen, nitrogen or sulfur heteroatoms. A heteroaryl group can be attached to the remainder of the molecule through a carbon or heteroatom. Especially preferred heteroaryl groups include 1,2,3-triazole, 1,2,4-triazole, 5-amino 1,2,4-triazole, imidazole, oxazole, isoxazole, 1,2,3-oxadiazole, 1,2,4-oxadiazole, 3-amino-1,2,4-oxadiazole, 1,2,5-oxadiazole, 1,3,4-oxadiazole, pyridine, 2-aminopyridine, 4-aminopyridine, 2-aminoimidazoline, and 4-aminoimidazoline.

An “amino” group as used herein refers to an —NH₂ group.

An “amido” group as used herein refers to an —CONH₂ group. An alkylamido group as used herein refers to an —CONHR group wherein R is as defined above. A dialkylamido group as used herein refers to an —CONRR′ group wherein R and R′ are as defined above.

The term “halogen” or “halo” as used herein by itself or as part of another group refers to chlorine, bromine, fluorine or iodine.

The term “hydroxy” or “hydroxyl” as used herein by itself or as part of another group refers to an —OH group.

An “alkoxy” group as used herein refers to an —O-alkyl group wherein “alkyl” is as defined above. In one embodiment, the alkyl group has 1-12 carbons. In another embodiment, the alkyl group has 1-7 carbons. In a further embodiment, the alkyl group has 1-6 carbons. In another embodiment, the alkyl group has 1~4 carbons.

A “thio” group as used herein refers to an —SH group.

An “alkylthio” group us used herein refers to an —SR group wherein R is alkyl as defined above.

The term “heterocycle” or “heterocyclic ring”, as used herein except where noted, represents a stable 5- to 7-membered monocyclic-, or stable 7- to 11-membered bicyclic heterocyclic ring system, any ring of which may be saturated or unsaturated, and which consists of carbon atoms and from one to three heteroatoms selected from the group consisting of N, O and S, and wherein the nitrogen and sulfur heteroatoms may optionally be oxidized, and the nitrogen heteroatom may optionally be quaternized, and including any bicyclic group in which any of the above-defined heterocyclic rings is fused to a benzene ring. Rings may contain one oxygen or sulfur, one to three nitrogen atoms, or one oxygen or sulfur combined with one or two nitrogen atoms. The heterocyclic ring may be attached at any heteroatom or carbon atom that results in the creation of a stable structure.

The term “selective” or “selectivity” as used herein, refers to the ratio of permeabilities of gases in a mixture.

The term “pyrolysis”, as used herein, refers to a process of heating a material in a temperature-controlled atmosphere to impart thermal decomposition of said material. In some embodiments, the pyrolysis occurs in the presence of an atmosphere (i.e., gaseous conditions) comprising nitrogen, argon, helium, oxygen, air, or a combination thereof. The term “pyrolysis temperature” as used herein generally refers to a temperature at which said material is processed to form carbon molecular sieve membranes.

The term “carbon molecular sieve” (CMS), as used herein, refers to a porous carbonaceous material. Examples of carbon molecular sieves as used herein include carbon molecular sieves containing 50-100% carbon. The carbon molecular sieves may have ultramicropores (e.g., in the range of about 0.2 to about 1 nanometer in diameter). In some embodiments, said carbon molecular sieve membrane, may include at least 20, about 20 to about 1,000,000, about 100 to about 1,000,000 or about 1000 to about 100,000, about 30 to about 10,000 hollow fibers.

The term “fluid stream” as used herein refers to a gaseous fluid comprising a mixture of two or more gases.

The term “tube” as used herein refers to a hollow cylinder. The tube may be straight, curved, or bent. The tube may be made of metal, quartz, or other appropriate material known in the art.

It is to be understood that both the foregoing descriptions are exemplary, and thus do not restrict the scope of the invention.

### LIST OF EMBODIMENTS

The following is a list of non-limiting embodiments:
1. A method of making a carbon molecular sieve (CMS) hollow fiber membrane, said method comprising
   a. providing a precursor hollow fiber membrane;
   b. inserting said precursor hollow fiber membrane into a tubing (such as a metal tubing, e.g., a stainless-steel tubing with e.g., ⅜ inch outer diameter); and
   c. pyrolyzing said precursor membrane (e.g., in a furnace, such as a three-zone tube furnace) to obtain a CMS hollow fiber membrane.
2. The method of embodiment 1, wherein said CMS hollow fiber membrane is selective for carbon dioxide gas over methane gas (or helium over nitrogen gas); wherein said CMS hollow fiber membrane has a selectivity for carbon dioxide gas over methane gas in the range of about 1 to about 100,000 (e.g., about 10 to about 10,000); and/or wherein said CMS hollow fiber membrane has a permeance of helium, CO₂, or H₂ gas (or combinations thereof) in the range of about 1 to about 10,000 GPU (gas permanence units).
3. The method of embodiment 1, further comprising sealing said precursor hollow fiber membrane by placing an end of said precursor hollow fiber membrane in a solution of said precursor hollow fiber membrane (e.g., a 5 wt % solution in a solvent, e.g., THF) and drying (e.g. overnight); wherein said sealing takes place after providing said precursor hollow fiber membrane.
4. The method of any of the preceding embodiments, wherein said precursor hollow fiber membrane comprises a material chosen from polysulfones, poly(styrenes) (e.g., styrene-containing copolymers such as acrylonitrilestyrene copolymers, styrene-butadiene copolymers and styrene-vinylbenzylhalide copolymers), polycarbonates, cellulosic polymers (e.g., cellulose acetate-butyrate, cellulose propionate, ethyl cellulose, methyl cellulose, nitrocellulose, etc.), poly-amides and polyimides (e.g., polyamides and polyimides, e.g., P84, MATRIMID® 5218), polyethers, polyetherimides, polyetherketones, poly(arylene oxides) (e.g., poly(phenylene oxide) and poly(xylene oxide)), poly(esteramide-diisocyanate), polyurethanes, polyesters (e.g., polyarylates, e.g., poly(ethylene terephthalate), poly(alkyl methacrylates), poly(acrylates), poly(phenylene terephthalate), etc.), polypyrrolones, polysulfides, polymers from monomers having alpha-olefinic unsaturation other than mentioned above (e.g., poly(ethylene), poly(propylene), poly(butene-1), poly(4-methyl pentene-1), polyvinyls [e.g., poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates)], polyallyls, poly(benzobenzimidazole), polyhydrazides, polyoxadiazoles, polytriazoles, poly(benzimidazole), polycarbodiimides, polyphosphazines, etc.), and interpolymers (e.g., block interpolymers containing repeating units from the above e.g., terpolymers of acrylonitrile-vinyl bromide-sodium salt of para-sulfophenylmethallyl ethers); and grafts, blends, and combinations thereof.
5. The method of any of the preceding embodiments, wherein said CMS hollow fiber membrane comprises at least 5 hollow fibers, at least 10 hollow fibers, at least 20 hollow fibers, about 10 to about 1,000,000, about 20 to about 1,000,000, 100 to about 1,000,00, about 1000 to about 100,000, or about 30 to about 10,000 hollow fibers.
6. The method of any of the preceding embodiments, wherein said pyrolyzing comprises heating said precursor hollow fiber membrane to a pyrolysis temperature (i.e. a temperature where precursor hollow fiber membrane pyrolyzes).
7. The method of embodiment 6, wherein said pyrolysis temperature is in the range of about 500° C. to about 1500° C. (e.g., about 500° C. to about 900° C., about 500° C. to about 800° C., about 500° C. to about 700° C., about 600° C. to about 700° C., about 675° C., about 1200° C.).
8. The method of any of the preceding embodiments, wherein heating said precursor hollow fiber membrane to a pyrolysis temperature comprises one or more temperature ramps.
9. The method of embodiment 8, comprising a first temperature ramp, a second temperature ramp, and a third temperature ramp;
   wherein said first temperature ramp comprises heating from room temperature to a first temperature at a first ramp rate in the range of 0 to 100° C./min;
   wherein said second temperature ramp comprises heating from said first temperature to a second temperature at a second ramp rate in the range of 0 to 100° C./min;
   wherein said third temperature ramp comprises heating from said second temperature to said pyrolysis temperature (e.g., about 675° C.) at a third ramp rate in the range of 0 to 100° C./min.
10. The method of embodiment 8, comprising a first temperature ramp, a second temperature ramp, and a third temperature ramp;
   wherein said first temperature ramp comprises heating from room temperature to about 250° C. at a first ramp rate of 13.3° C./min;
   wherein said second temperature ramp comprises hearing from about 250° C. to about 660° C. at a second ramp rate of 3.85° C./min;
   wherein said third temperature ramp comprises heating from about 660° C. to said pyrolysis temperature (e.g., about 675° C.) at a third ramp rate of 0.25° C./min.
11. The method of any of the preceding embodiments, wherein said pyrolysis temperature is held for a period of time (e.g., about 0 minutes to about 24 hours, about 2 hours, etc.).
12. The method of any of the preceding embodiments, wherein said pyrolyzing occurs in the presence of an atmosphere comprising nitrogen, argon, helium, oxygen, air, or a combination thereof (e.g., argon, e.g., ultra-high purity argon).
13. The method of any of the preceding embodiments, wherein said pyrolyzing occurs in vacuum.
14. The method of any of the preceding embodiments, wherein membrane comprises at least 5 hollow fibers, at least 10 hollow fibers, at least 20 hollow fibers, about 10 to about 1,000,000, about 20 to about 1,000,000, and said pyrolysis temperature is held for a period of time about 0 minutes to about 24 hours, or about 2 hours.
15. A carbon molecular sieve membrane, said membrane comprising at least 20, about 20 to about 1,000,000, about 100 to about 1,000,000 or about 1000 to about 100,000, about 30 to about 10,000 hollow fibers.
16. The membrane of embodiment 15, wherein said membrane produces a flow rate of 0.001 L/min to 10,000 L/min.
17. A method for separating at least a first component and a second component a gaseous mixture comprising:
   providing a carbon molecular sieve of any of the preceding embodiments, contacting said gaseous mixture (e.g., a fluid stream comprising 2 or more gases) comprising a first component and a second component with said carbon molecular sieve membrane to obtain
      a retentate stream having a reduced concentration of the first component, and a permeate stream having an increased concentration of the first component.
18. The method of embodiment 17, wherein said first component is chosen from CO₂, O₂, N₂, He, H₂, ethylene, propylene, n-butane, iso-butylene, butadiene, pentane isomers, hexane isomers, or xylene isomers, and combinations thereof.
19. The method of embodiment 17, wherein said second component is chosen from methane, N₂, CO₂, ethane, propane, iso-butane, pentane isomers, hexane isomers, or xylene isomers, and combinations thereof.
20. The method of embodiment 17, wherein the flow rate of the retentate steam is in the range of about 0.1 mol/s to about 1000 mol/s.
21. The method of embodiment 17, wherein the flow rate of the permeate steam is in the range of about 0.1 mol/s to about 1000 mol/s.
22. A carbon molecular sieve prepared according to any of a method according to any of the preceding embodiments.

### EXAMPLES

The following examples are provided solely to illustrate the present invention and are not intended to limit the scope of the invention, described herein.

### Example 1. Experimental Methods

### Materials

P84 polyimide was provided by Ensinger GmbH. Tetrahydrofuran (≥99.0%, anhydrous), LiNO₃ (ACS reagent), and N-Methyl-2-pyrrolidone (anhydrous, 99.5%) were obtained from Sigma Aldrich (St. Louis, MO). Hexane (≥98.5%, mixture of isomers) and methanol (≥99.8%) were obtained from VWR (Radnor, PA). All chemicals were used with no purification. Pure gases (ultra-high purity) were obtained from Airgas (Hyattsville, MD).

### Formation of Precursor Hollow Fiber Membrane

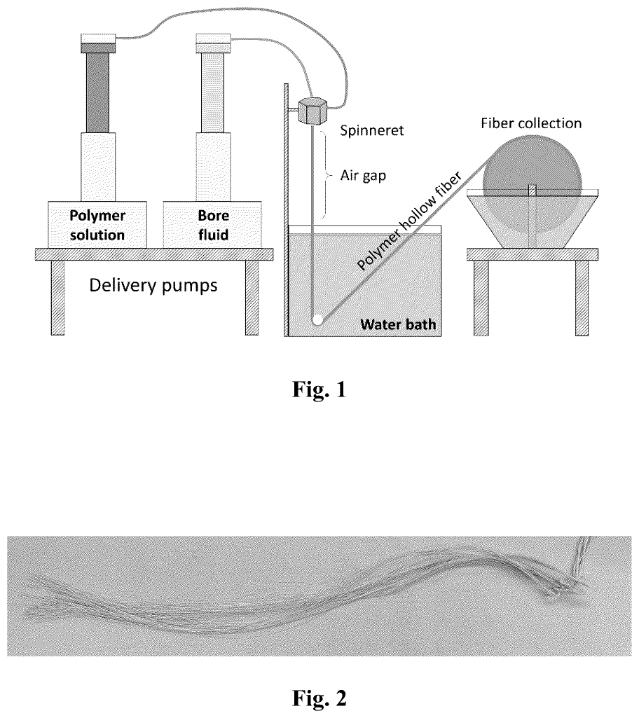

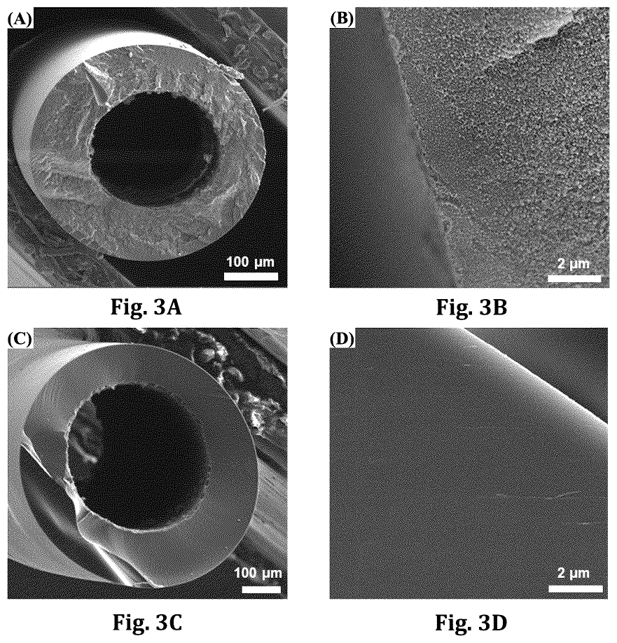

Monolithic P84 precursor hollow fiber membranes were fabricated using the dry-jet/wet-quench fiber spinning process^{3, 4} with a custom-built hollow fiber spinning system shown in FIG. 1. P84 polyimide powder was dried under vacuum at 110° C. for 15 hours for moisture removal. The polymer dope composition⁵ and spinning parameters are shown in Table 1 and 2, respectively. The as-spun precursor hollow fiber membranes were soaked in three separate deionized water baths over the course of 72 hours and solvent exchanged with three separate 20 min methanol baths followed by three 20 min hexane baths. After being dried in a fume hood overnight, the precursor hollow fibers were dried under vacuum at 75° C. for 12 hours. The resulting precursor hollow fibers are shown in FIG. 2.

TABLE 1
Spinning dope compositions of polyimide
precursor hollow fiber membranes.⁵

| Component | wt % |
|---|---|
| P84 | 28.5 |
| N-Methyl-2-pyrrolidone | 35.2 |
| Tetrahydrofuran (THF) | 35.3 |
| LiNO₃ | 1.0 |

TABLE 2
Spinning parameters of polyimide
precursor hollow fiber membranes.

| Spinning parameter | Value |
|---|---|
| Spinning temperature (° C.) | 22 |
| Quench bath temperature (° C.) | 22 |
| Dope flow rate (cc/hr) | 150 |
| Bore fluid* flow rate (cc/hr) | 50 |
| Air gap height (cm) | 5 |
| Fiber take-up rate (m/min) | 5 |

Bore fluid: 87% NMP/13% water

### Formation of CMS Hollow Fiber Membranes by Bundle Pyrolysis

One end of each precursor hollow fiber membrane was sealed by dipping in a 5 wt % MATRIMID®/THE solution and left in air overnight. A bundle of 27 precursor hollow fiber membranes was insert into a stainless steel tubing (⅜ inch outer diameter). The stainless steel tubing was then loaded into a three-zone tube furnace (MTI Corporation, Richmond, CA). Ultra-high purity (UHP) argon was introduced to the stainless steel tubing at 0.5 L/min using a mass flow controller (MTI Corporation, Richmond, CA). The oxygen level in the stainless steel tubing was kept below 5 ppm prior to pyrolysis, which was monitored by an oxygen analyzer (Cambridge Sensotec, Saint Ives, UK). The heating protocol comprises of (1) Room temperature to 250° C., 13.3° C./min; (2) 250° C. to 660, 3.85° C./min; (3) 660° C. to 675° C., 0.25° C./min; (4) Dwelling at 675° C. for 2 hours; (5) Natural cooling down to room temperature.

### Permeation Measurements in CMS Hollow Fiber Membranes

CMS hollow fiber membrane modules were made using stainless steel Swagelok® tubing and fittings. Epoxy resin (DURALCO™ 4525) was used for sealing. Single-gas permeation was performed using the constant pressure method⁷ at ambient temperature (~20° C.). The feed was introduced to the hollow fiber shell side. The permeate flow rate was measured using a bubble flow meter.

### Results and Discussion

### Formation of CMS Hollow Fiber Membranes by Bundle Pyrolysis

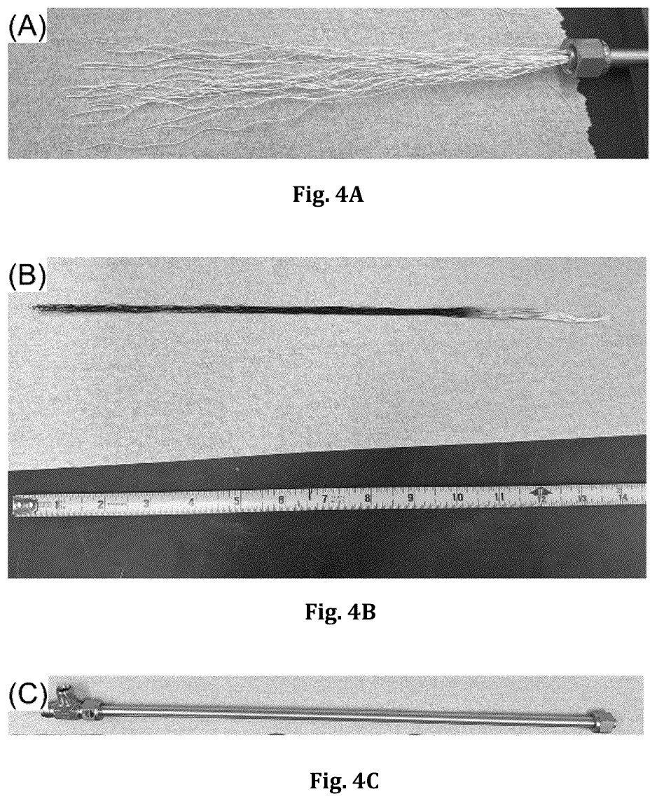

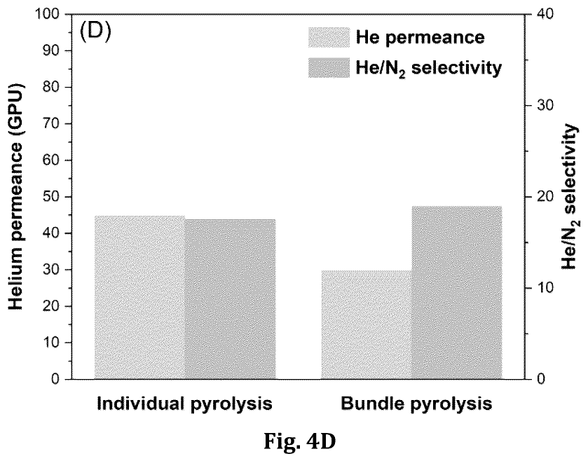

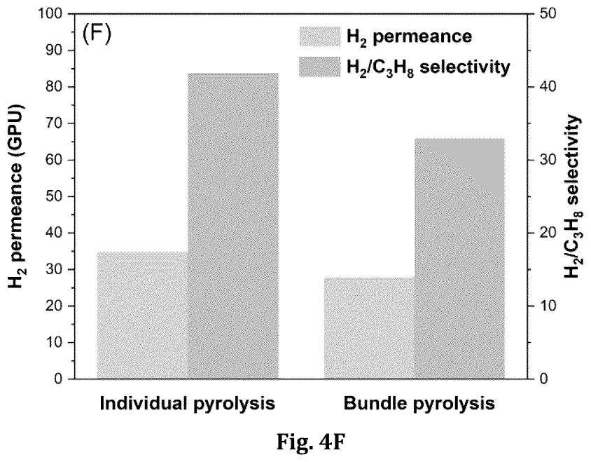

The precursor hollow fiber bundle and stainless steel tubing are shown in FIG. 4A. The CMS hollow fiber bundle was successfully formed without breaking fibers (FIG. 4B). The module containing the CMS hollow fiber bundle is shown in FIG. 4C. The polymer part of the CMS hollow fiber bundle was cut before module construction. It was evident from FIG. 4B that partial fusing of CMS hollow fiber membranes occurred during bundle pyrolysis.

### Gas Separation Performance in CMS Hollow Fiber Membranes Made by Bundle Pyrolysis

Single-gas helium and nitrogen permeation measurements were carried out at room temperature and transmembrane pressure ~0.5 bar. Compared with CMS hollow fiber membrane made by the traditional individual pyrolysis, the CMS hollow fiber membranes made by the novel bundle pyrolysis showed comparable He, CO₂, and H₂ permeance and almost identical He/N₂ (FIG. 4D), CO₂/CH₄ (FIG. 4E), and H₂/C₃H₈ (FIG. 4F) ideal selectivity. Not obvious to one skilled in the art, although partial fiber fusing occurred, the CMS hollow fiber made by bundle pyrolysis had only ~25% lower He permeance than the CMS hollow fiber membrane made by individual pyrolysis. This moderate drop in gas permeance can be considered acceptable given the benefits of high-speed production. The result suggests that the bundle pyrolysis method disclosed in this invention is effective to increase CMS hollow fiber membrane production speed without significantly sacrificing membrane separation performance.

### Example 2: Scaled-Up CMS Hollow Fiber Membranes Via Bundle Pyrolysis

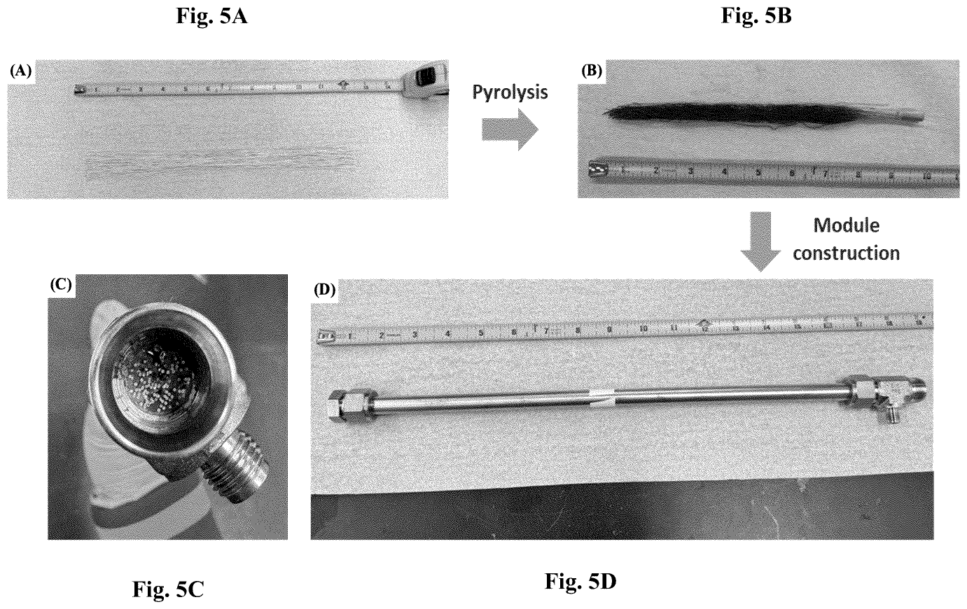

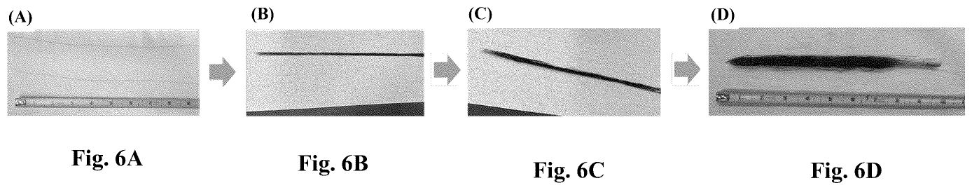

The protocol for Example 1 was repeated with the following adjustments: 100 CMS hollow fiber membranes were pyrolyzed instead of 27. The precursor hollow fiber bundle is shown in FIG. 5A. The CMS hollow fiber bundle was successfully formed without breaking fibers (FIG. 5B). FIG. 5C is the cross-section view of the module comprising 100 CMS hollow fibers made by bundle pyrolysis. FIG. 5D is the side view of the same module shown in FIG. 5C. These two figures are proof that a 100 CMS hollow fiber bundle was successfully made into a module for fluid separation. The polymer part of the CMS hollow fiber bundle was cut before module construction. It was evident from FIG. 5B that partial fusing of CMS hollow fiber membranes occurred during bundle pyrolysis.

### Procedure of Permeation Measurements

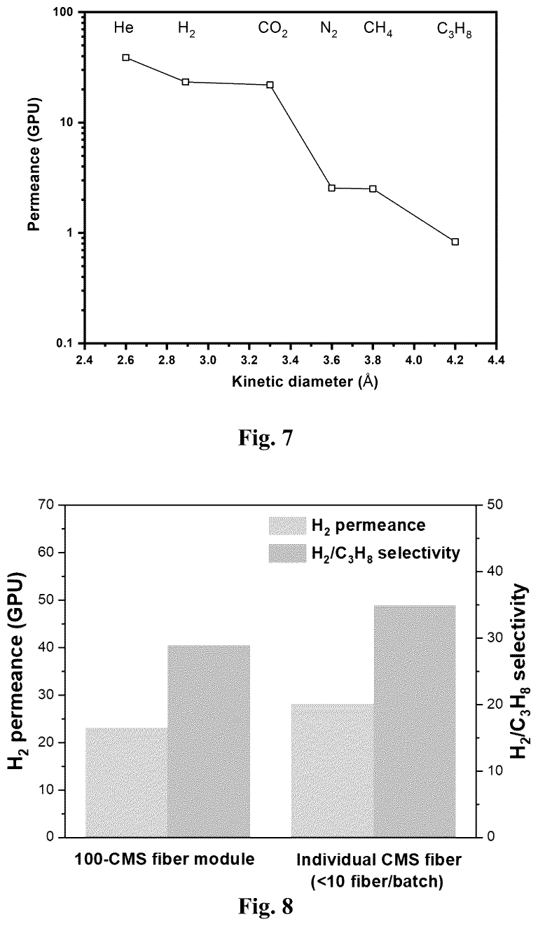

Single-gas permeation was performed using the constant-volume permeation method at 35° C. and feed pressure of 2 bar. The permeation data were collected by Labview. The graphs were plotted by Origin. FIGS. 7 and 8 describe the results of permeation measurements, which were used to examine the separation performance of CMS hollow fiber membranes made by bundle pyrolysis. They are important as they show bundle pyrolysis can scale up CMS hollow fiber membranes without losing separation performance.

### REFERENCES

A number of patents and publications are cited above in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.
ADDIN EN.REFLIST 1. Robeson, L. M., The upper bound revisited. Journal of Membrane Science 2008, 320 (1-2), 390-400.
2. Zhang, C.; Koros, W. J., Ultraselective Carbon Molecular Sieve Membranes with Tailored Synergistic Sorption Selective Properties. Advanced Materials 2017, 29 (33), 1701631.
3. Xu, L.; Zhang, C.; Rungta, M.; Qiu, W.; Liu, J.; Koros, W. J., Formation of defect-free 6FDA-DAM asymmetric hollow fiber membranes for gas separations. Journal of Membrane Science 2014, 459, 223-232.
4. Xu, L. Ph.D. Dissertation. Georgia Institute of Technology, 2012.
5. Clausi, D. T.; Koros, W. J., Formation of defect-free polyimide hollow fiber membranes for gas separations. Journal of Membrane Science 2000, 167 (1), 79-89.
6. Bhuwania, N.; Labreche, Y.; Achoundong, C. S.; Baltazar, J.; Burgess, S. K.; Karwa, S.; Xu, L.; Henderson, C. L.; Williams, P. J.; Koros, W. J., Engineering substructure morphology of asymmetric carbon molecular sieve hollow fiber membranes. Carbon 2014, 76, 417-434.
7. Zhang, C.; Wenz, G. B.; Williams, P. J.; Mayne, J. M.; Liu, G.; Koros, W. J., Purification of Aggressive Supercritical Natural Gas Using Carbon Molecular Sieve Hollow Fiber Membranes. Industrial & Engineering Chemistry Research 2017, 56 (37), 10482-10490.

We claim:

1. A method of making a carbon molecular sieve (CMS) hollow fiber membrane, said method comprising:
a. providing a precursor hollow fiber membrane;
b. inserting said precursor hollow fiber membrane into a tubing; and
c. pyrolyzing said precursor membrane to obtain a CMS hollow fiber membrane,
wherein said CMS hollow fiber membrane contains at least 5 hollow fibers.

2. The method of claim 1, wherein said CMS hollow fiber membrane is selective for carbon dioxide gas over methane gas or helium over nitrogen gas; wherein said CMS hollow fiber membrane has a selectivity for carbon dioxide gas over methane gas in the range of about 1 to about 100,000 and/or wherein said CMS hollow fiber membrane has a permeance of helium, carbon dioxide, hydrogen gas, or combinations thereof in the range of about 1 to about 10,000 GPU (gas permanence units).

3. The method of claim 1, further comprising sealing said precursor hollow fiber membrane by placing an end of said precursor hollow fiber membrane in a solution of said precursor hollow fiber membrane and drying; wherein said sealing takes place after providing said precursor hollow fiber membrane.

4. The method of claim 1, wherein said precursor hollow fiber membrane comprises a material chosen from polysulfones, poly(styrenes), polycarbonates, cellulosic polymers, polyamides, polyimides, polyethers, polyetherimides, polyetherketones, poly(arylene oxides), poly(esteramide-diisocyanate), polyurethanes, polyesters, polypyrrolones, polysulfides, polybenzimidazole, polymers from monomers having alpha-olefinic unsaturation other than mentioned above, interpolymers; and grafts, blends, and combinations thereof.

5. The method of claim 1, wherein said CMS hollow fiber membrane comprises at least 10 hollow fibers, at least 20 hollow fibers, about 10 to about 1,000,000, about 20 to about 1,000,000, 100 to about 1,000,00, about 1000 to about 100,000, or about 30 to about 10,000 hollow fibers.

6. The method of claim 1, wherein said pyrolyzing comprises heating said precursor hollow fiber membrane to a pyrolysis temperature.

7. The method of claim 6, wherein said pyrolysis temperature is in the range of about 500° C. to about 1500° C.

8. The method of claim 6, wherein heating said precursor hollow fiber membrane to a pyrolysis temperature comprises one or more temperature ramps.

9. The method of claim 6, wherein said pyrolysis temperature is held for a period of time.

10. The method of claim 6, wherein said pyrolyzing occurs in the presence of an atmosphere comprising nitrogen, argon, helium, oxygen, air, or a combination thereof.

11. The method of claim 6, wherein said pyrolyzing occurs in vacuum.

12. The method of claim 6, wherein membrane comprises at least 10 hollow fibers, at least 20 hollow fibers, about 10 to about 1,000,000, about 20 to about 1,000,000, and said pyrolysis temperature is held for a period of time about 0 minutes to about 24 hours.

13. A carbon molecular sieve membrane, said membrane comprising at least 20, about 20 to about 1,000,000, about 100 to about 1,000,000 or about 1000 to about 100,000, about 30 to about 10,000 hollow fibers.

14. The membrane of claim 13, wherein said membrane produces a flow rate of 0.001 L/min to 10,000 L/min.

15. A method for separating at least a first component and a second component a gaseous mixture comprising:
a. providing a carbon molecular sieve membrane of claim 13,
b contacting said gaseous mixture comprising a first component and a second component with said carbon molecular sieve membrane to obtain a retentate stream having a reduced concentration of the first component, and a permeate stream having an increased concentration of the first component.

16. The method of claim 15, wherein said first component is chosen from CO₂, O₂, N₂, He, H₂, ethylene, propylene, n-butane, iso-butylene, butadiene, pentane isomers, hexane isomers, or xylene isomers, and combinations thereof.

17. The method of claim 15, wherein said second component is chosen from methane, N₂, CO₂, ethane, propane, iso-butane, pentane isomers, hexane isomers, or xylene isomers, and combinations thereof.

18. The method of claim 15, wherein the flow rate of the retentate steam is in the range of about 0.1 mol/s to about 1000 mol/s.
